(19) United States
(12) Patent Application Publication
(10) Pub. No.: US 2011/0096846 A1
(43) Pub. Date: Apr. 28, 2011

(54) ADVERTISEMENT INSERTION FOR VIDEO

(76) Inventors: Santhana Chari, Mableton, GA (US); Alexander D. Raji, Alpharetta, GA (US); Junfeng Bai, Atlanta, GA (US)

(21) Appl. No.: 12/891,022

(22) Filed: Sep. 27, 2010

Related U.S. Application Data
(60) Provisional application No. 61/255,033, filed on Oct. 26, 2009.

(51) Int. Cl. H04N 7/26

(52) U.S. Cl. 375/240.26; 375/E07.198

(57) ABSTRACT

Methods for performing ad insertion prior to performing statistical multiplexing on one or more digital video streams including programs are disclosed. Select coded frames of a program and an advertisement are decoded and re-encoded at a predetermine bit rate to obtain a revised program representing the original program with the advertisement inserted at a select time.

### TECHNICAL FIELD

This disclosure relates to advertisement insertion for video.

### BACKGROUND

FIG. 1 illustrates a high-level general system for distributing programs from broadcasters to a headend. Analog and/or digital programs are received from broadcasters via analog receivers 110 and digital receivers 120. For image quality, broadcasters may transmit these programs at a relatively high bandwidth. The analog programs can be processed by processors 130 to convert the programs to digital video streams. The digital video streams 140 from processors 130 can be single program transport streams as defined in the MPEG-2 (ISO/IEC 13818) standard. The digital video streams 140 from digital receivers 120 can be multiple program transport streams as defined in the MPEG-2 standard.

To produce a digital video stream 160 that includes the programs from the multiple digital video streams 140 for transmission on a channel having a certain data capacity, transcoder 150 can statistically multiplex the programs of the digital video streams 140. With statistical multiplexing, the total data capacity of the channel is shared among the programs of the digital video streams 140. Thus, the transcoder 150 can allocate varying bit rates to the programs of the digital video streams 140 depending, for example, on the complexity of the programs of the digital video streams 140. The resulting encoded programs are combined to produce a digital video stream 160.

The digital video stream 160 from transcoder 150 can be received by an ad splicer 170 to insert advertisements stored in an ad server 180 into the programs of the digital video stream 160. However, a problem can arise if the bandwidth for an advertisement to be inserted into a program exceeds the bandwidth allocated to the program by transcoder 150 at the time of the ad insertion.

This bandwidth mismatch problem has been addressed by limiting the ad bandwidth to strict bit-rate levels, processing the ad to fit the available bandwidth, limiting the lower limit of the program bandwidth, or at the time of ad insertion, borrowing bandwidth from other programs that do not require ad insertion. However, in each of these approaches, the quality of the programs and the quality of the advertisement can be compromised.

### BRIEF DESCRIPTION OF THE DRAWINGS

FIG. 1 illustrates an example high-level general system for distributing programs from broadcasters to a headend.

FIG. 2 illustrates an example distribution system.

FIG. 3 illustrates an example process for inserting an advertisement into a program.

FIG. 4 illustrates an example first stage of the ad insertion process of FIG. 3.

FIG. 5 illustrates an example second stage of the ad insertion process of FIG. 3.

FIG. 6 illustrates an example third stage of the ad insertion process of FIG. 3.

FIG. 7 illustrates an example fourth stage of the ad insertion process of FIG. 3 in more detail.

FIGS. 8-11 illustrate the relationship between access units of a program and/or advertisement and the frame outputs of a decoder and illustrates examples showing which access units can be transmitted to the decoder to perform the processes of FIGS. 4-7.

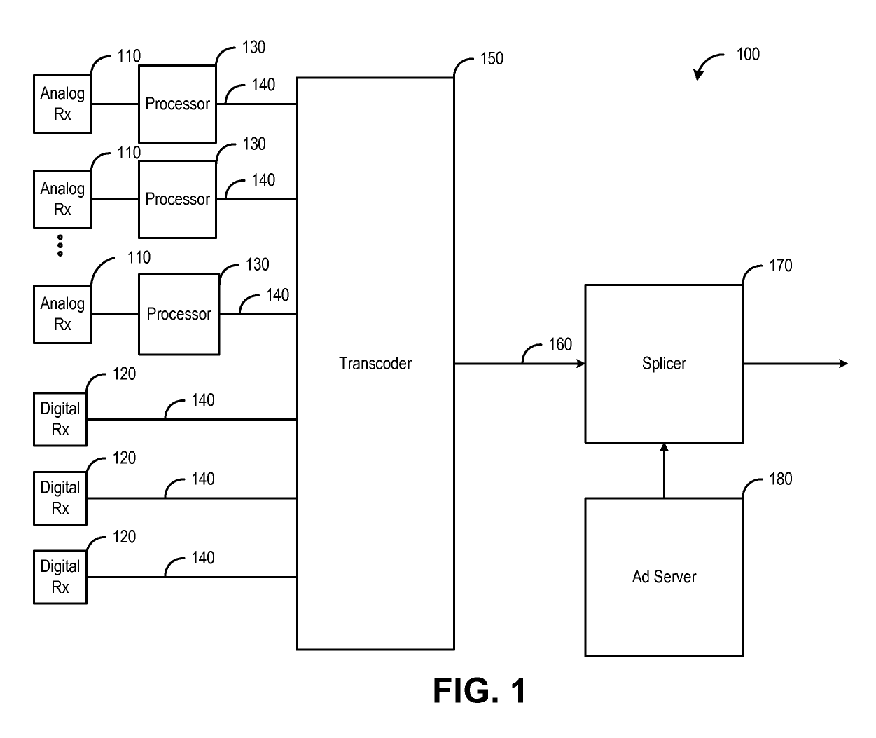

### DETAILED DESCRIPTION

Various implementations of this disclosure address the bandwidth mismatch problem by inserting an advertisement into a program stream prior to the bit rate allocation process performed by a transcoder to allocate bit rates to the various program streams.

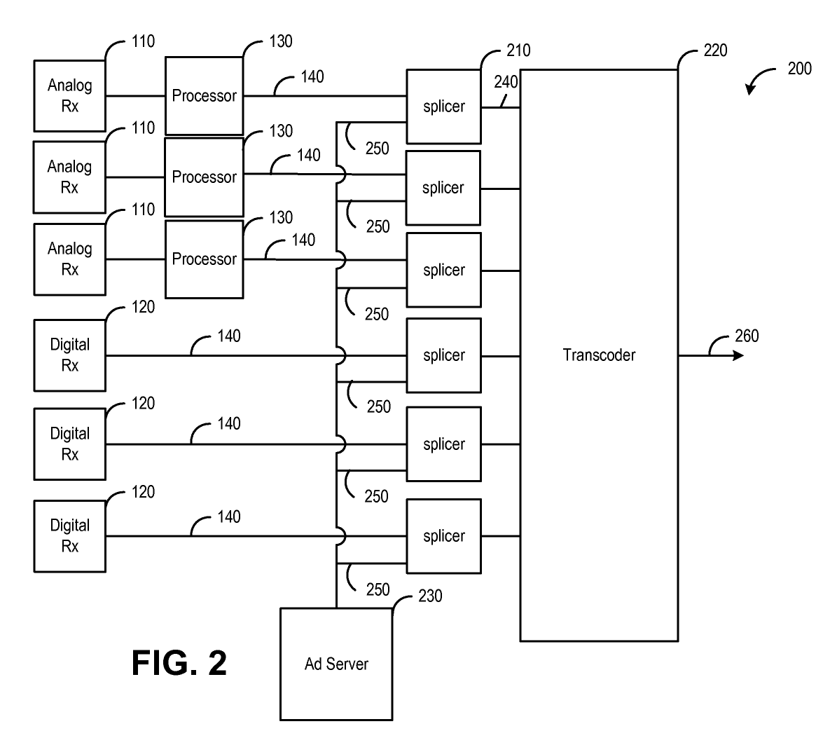

FIG. 2 illustrates an example distribution system 200 according to an example implementation. Analog and/or digital programs from broadcasters are received via analog receivers 110 and digital receivers 120. The analog programs can be processed by processors 130 to convert the programs to digital video streams 140. The digital video streams 140 from processors 130 can be single program transport streams as defined in the MPEG-2 standard. The digital video streams 140 from the digital receivers 120 can be multiple program transport streams as defined in the MPEG-2 standard. The digital video streams 140 can be received by an ad splicer 210 to insert advertisements stored in an ad server 230 into the programs of the digital video streams 140. Accordingly, transcoder 220 receives as its input digital video streams 240 representing the original digital video streams 140 with ads inserted by splicer 210. Thereafter, to produce a digital video stream 260 that includes the programs from the digital video streams 140 with ad insertion for transmission on a channel having a certain data capacity, transcoder 220 can statistically multiplex the programs of the digital video streams 140 with the ads already inserted. In this way, the bandwidth mismatch problem can be avoided. In some implementations, the digital video streams can be H.264/AVC compliant.

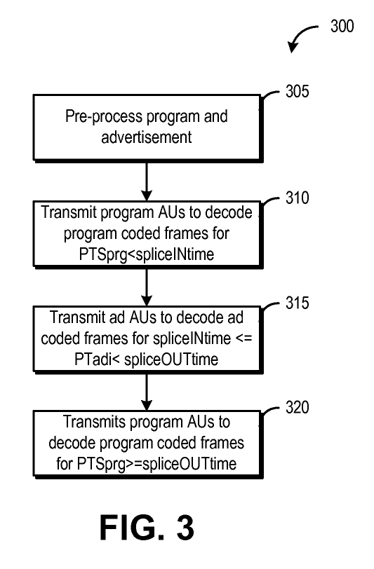

FIG. 3 illustrates a process 300 for inserting an advertisement into a program. In some implementations, the process 300 can be performed by splicer 210. Although the following disclosure is described with respect to splicer 210, in some implementations, process 300 can be performed by one or more programmable processors or can also be performed by, and apparatus can also be implemented as, special purpose logic circuitry, e.g., an FPGA (field programmable gate array) or an ASIC (application specific integrated circuit). Furthermore, the separation of various system components in the implementations described above should not be understood as requiring such separation in all implementation. It should be understood that the described program components and systems can generally be integrated together in a single software product or packaged into multiple software products operating on the same processor or device or distributed across multiple processors or devices.

At stage 305, splicer 210 preprocesses a digital video streams 140 containing a program and a digital video stream 250 containing an advertisement. In some implementations, splicer 210 preprocesses these digital video streams to extract a video elementary stream (e.g., the Video Packetized Elementary Stream as defined in the MPEG-2 standard) representing a program and a video elementary stream representing an advertisement to be inserted in the program. In some implementations, the video elementary stream representing a program or advertisement can include coded frames (e.g., intra-coded frames (i-frames), predicted frames (p-frames), and bi-directional predicted frames (b-frames)) as defined in the MPEG-2 standard.

At stage 310, program access units (AUs) are transmitted to decode program coded frames for PTS_{prg}<spliceINtime. For example, a splicer (e.g., splicer 210 of FIG. 2) can transmit to the decoder of a transcoder (e.g., transcoder 220 of FIG. 2) certain access units (discussed in detail below) of the program to decode the coded frames of the program for PTS_{prg}<spliceINtime.

At stage 315, advertisement access units can be transmitted to decode ad coded frames for spliceINtime≦PTS_{ad}_{ᵢ}<spliceOUTtime. For example, a splicer (e.g., splicer 210 of FIG. 2) can transmit access units of the advertisement to be inserted in the program to the decoder of a transcoder (e.g., transcoder 220 of FIG. 2) to decode the coded frames of the ad for spliceINtime≦PTS_{ad}_{ᵢ}<spliceOUTtime.

At stage 320, program access units are transmitted to decode program coded frames for PTS_{prg}≧spliceOUTtime. For example, a splicer (e.g., splicer 210 of FIG. 2) can transmit certain access units of the program to the decoder of a transcoder (e.g., transcoder 220 of FIG. 2) to decode the coded frames of the program for PTS_{prg}≧spliceOUTtime.

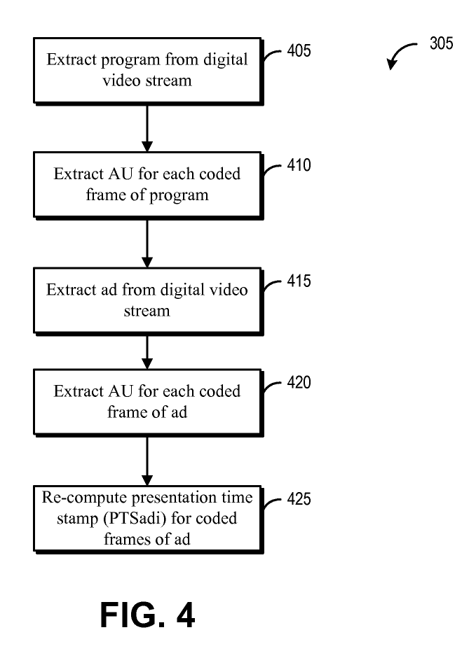

FIG. 4 illustrates an example process associated with stage 305 of the ad insertion process of FIG. 3 in more detail. At stage 405, a program is extracted from a digital video stream. For example, a splicer (e.g., splicer 210 of FIG. 2) can extract a video elementary stream representing a program from a digital video stream (e.g., digital video stream 140 of FIG. 2).

At stage 410, an access unit for each coded frame of the program is extracted. The access unit can be extracted for each coded frame of the program, for example, by a splicer (e.g., splicer 210 of FIG. 2). The access units contain enough information for the decoder of a transcoder (e.g., transcoder 220 of FIG. 2) to decode the coded frames of the program. Thus, in some implementations, each access unit contains the frame type and presentation time stamp, PTS_{prg}, of the respective coded frame of the program along with the coded frame.

At stage 415, an advertisement can be extracted from the digital video stream. For example, a splicer (e.g., splicer 210 of FIG. 2) can extract a video elementary stream representing an advertisement from a digital video stream (e.g., digital video stream 250 of FIG. 2) from an ad server (e.g., ad server 230 of FIG. 2).

At stage 420, an access unit for each coded frame of an advertisement can be extracted. The access units for each coded frame of the advertisement can be extracted, for example, by a splicer (e.g., splicer 210 of FIG. 2). The access unit(s) can contain the frame type and presentation time stamp, PTS_{ad}, of the respective coded frame of the advertisement along with the coded frame.

At stage 425, a presentation time for the coded frames of the advertisement can be re-computed. For example, a splicer (e.g., splicer 210 of FIG. 2) can re-compute the presentation time stamp for the coded frames of the advertisement, PTS_{ad}, based on the time in the program for the insertion of an advertisement (i.e., spliceINtime). In some implementations, splicer 210 re-computes the presentation time for the i-th coded frame of the advertisement, PTS_{ad}_{ᵢ}, based on the equation:

PTS_{ad}_{_{i′}}=PTS_{ad}_{ᵢ}+offset

where offset=spliceINtime−PTS_{ad}_{₁} and

PTS_{ad}_{₁} is the presentation time for the first coded frame of the advertisement.

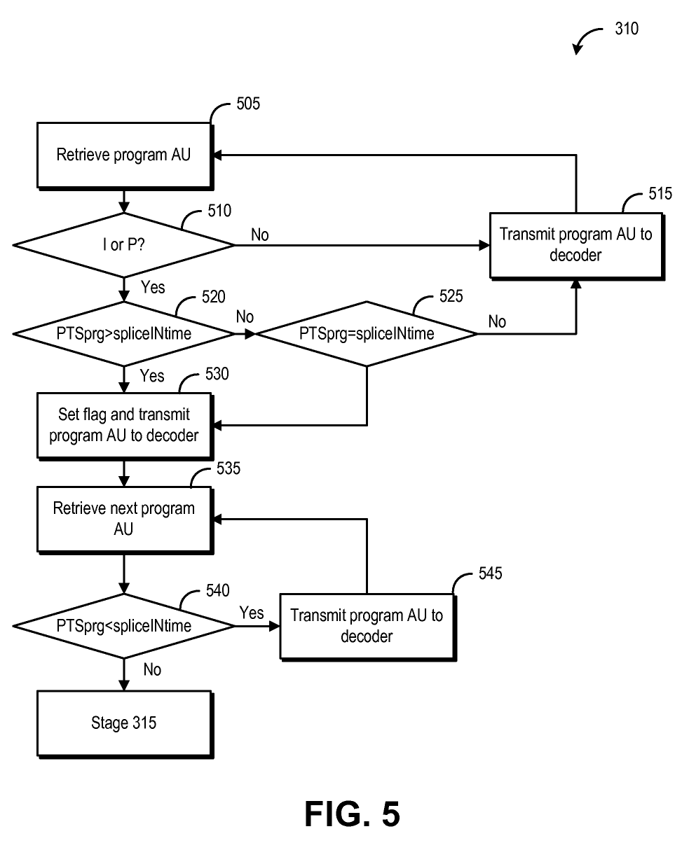

FIG. 5 illustrates an example process associated with stage 310 of the ad insertion process of FIG. 3 in more detail. To decode the coded frames of the program for PTS_{prg}<spliceINtime, splicer 210 transmits to the decoder of transcoder 220 certain access units of the program. These access units can include the access units for PTS_{prg}<spliceINtime and, in some implementations, include other access units, for example, access units for PTS_{prg}>spliceINtime, that may be needed to decode the access units for PTS_{prg}<spliceINtime.

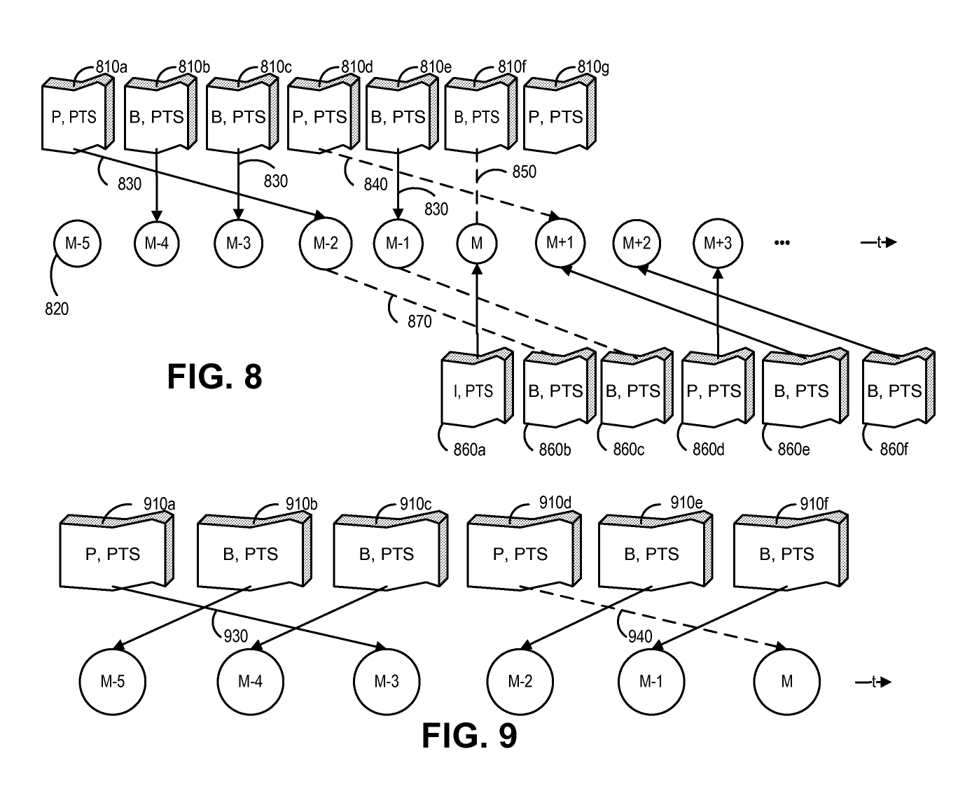

For example, FIG. 8 illustrates an example of access units 810a-g that can be extracted from a program wherein, as discussed above, each access unit 810 contains the frame type and the presentation time stamp, PTS_{prg}, of the corresponding coded frame of the program along with the coded frame. The example access units 810 are illustrated in the order in which they can be encoded.

FIG. 8 also illustrates the relationship between the access units 810 and the frame outputs 820 in display order of the decoder of transcoder 220 for the decoded frames for the access unit 810. For example, FIG. 8 illustrates that the frame output for the decoded frame for the access unit 810f having PTS_{prg}=spliceINtime is at position M whereas the frame output for the decoded frame for access unit 810e is at position M−1 and the frame output for the decoded frame for access unit 810d is at position M+1. Thus, the presentation time stamp for access unit 810d is greater than the presentation time stamp for access unit 810f.

Assuming the presentation time for output M corresponds to spliceINtime, FIG. 8 illustrates that to decode one or more coded frames of the program for PTS_{prg}<spliceINtime (e.g., to decode the coded frames for access units 810a, b, c, and e), access units for PTS_{prg}<spliceINtime must be transmitted to the decoder of transcoder 220 (this is represented by solid arrow lines 830) and one or more access units for PTS_{prg}>spliceINtime also may be needed. For example, access unit 810e corresponds to a coded b-frame of the program for PTS_{prg}<spliceINtime and access unit 810d, which corresponds to a coded p-frame for PTS_{prg}>spliceINtime, may be needed to decode the coded b-frame for access unit 810e. Accordingly, in some implementations, access unit 810d can be transmitted to the decoder of a transcoder (e.g., transcoder 220 of FIG. 2). However, in some implementations, the coded frame for access unit 810d is not used as a decoder output for display. The dotted line with an arrow 840 represents that access unit 810d can be transmitted to the decoder of transcoder (e.g., transcoder 220 of FIG. 2), however, the coded frame for access unit 810d should not be used as a decoder output for display.

FIG. 8 illustrates an example for when the coded frame of the program for PTS_{prg}=spliceINtime is a b-frame. As shown in FIG. 8, when the access unit 810f of the program for PTS_{prg}=spliceINtime corresponds to a coded b-frame, in some implementations, the access unit need not be transmitted to the decoder. This is represented by the dotted line 850.

FIG. 9 illustrates an example for when the coded frame of the program for PTS_{prg}=spliceINtime is a reference frame (e.g., an i-frame or p-frame).

Returning to FIG. 5, the process of FIG. 5 will be described with reference to FIGS. 8 and 9. To decode the coded frames of the program for PTS_{prg}<spliceINtime, at stage 505, a program access unit is retrieved. For example, a splicer (e.g., splicer 210 of FIG. 2) can retrieve a program access unit. At stage 510, a determination can be made whether the coded frame of the access unit is a reference frame. For example, a splicer (e.g., splicer 210 of FIG. 2) can determine whether the coded frame of the access unit is a reference frame. If the coded frame of the access unit is not a reference frame (e.g., if the coded frame is a b-frame), the process proceeds to stage 515, where the program access unit is transmitted to a decoder. For example, a splicer (e.g., splicer 210 of FIG. 2) can transmit the program access unit to the decoder of a transcoder (e.g., transcoder 220 of FIG. 2) and can retrieve the next program access unit at stage 505. The splicer can continue to transmit program access units to the decoder of the transcoder until it reaches the first reference frame of the program (for example, the reference frame of access unit 810a or 910a).

When the coded frame of the access unit is a reference frame, the process can proceed to stage 520, where a determination is made whether the presentation time stamp, PTS_{prg}, of the access unit is greater than the spliceINtime. For example, a splicer (e.g., splicer 210 of FIG. 2) determines whether the presentation time stamp, PTS_{prg}, of the access unit is greater than the spliceINtime (e.g., whether PTS_{prg}>spliceINtime).

If PTS_{prg} of the access unit is not greater than the spliceINtime (for example, access unit 810a, 910a is not greater than spliceINtime), then the process proceeds to stage 525, where a determination is made whether the presentation time stamp, PTS_{prg}, of the access unit is equal to the spliceINtime. For example, a splicer (e.g., splicer 210 of FIG. 2) can determine whether the presentation time stamp, PTS_{prg}, of the access unit is equal to the spliceINtime (i.e., whether PTS_{prg}=spliceINtime) (for example, access unit 810a, 910a is not equal to spliceINtime).

If PTS_{prg} of the access unit is not equal to the spliceINtime, then PTS_{prg} of the access unit is less than the spliceINtime and, therefore, at stage 515 the program access unit is transmitted to a decoder. For example, a splicer (e.g., splicer 210 of FIG. 2) transmits the program access unit to the decoder of a transcoder (e.g., transcoder 220 of FIG. 2) (for example this is illustrated by arrow 830 for access unit 810a and arrow 930 for access unit 910a) and at stage 505 the process retrieves the next program access unit (for example, access unit 810b or 910b). At this stage, splicer 210 continues to retrieve and transmit program access units (for example, access units 810b, c or 910b, c) to the decoder of transcoder 220 until it reaches the next reference frame of the program (for example access units 810d or 910d).

When the coded frame of the access unit is a reference frame (for example, the coded frames of access units 810d and 910d) and PTS_{prg} of the access unit is greater than the spliceINtime (i.e., Yes at stage 520) (for example PTS_{prg} of access unit 810d is greater than the spliceINtime) or equal to the spliceINtime (for example PTS_{prg} of access unit 910d is equal to the spliceINtime), then the process proceeds to stage 530 (in some implementations, the first reference frame for PTS_{prg}≧spliceINtime satisfies this stage), where a flag is set in the access unit and the access unit is transmitted to a decoder. For example, a splicer (e.g., splicer 210 of FIG. 2) sets a flag in the access unit and transmits the access unit to the decoder of a transcoder (e.g., transcoder 220 of FIG. 2). The flag indicates that the corresponding coded frame of the access unit can be used to decode other coded frames of the video sequence having PTS_{prg}<spliceINtime (for example the coded frame for access unit 810e and the coded frames for access units 910e, f) but is not used as a decoder output and transmits the access unit to the decoder of a transcoder (e.g., transcoder 220 of FIG. 2). This stage is represented by the dotted arrow 840 for access unit 810d and 940 for access unit 910d.

Subsequent access units are retrieved at stage 535 (e.g., by splicer 210) and transmits at stage 545 to a decoder so long as the presentation time stamp, PTS_{prg}, of the access unit is less than the spliceINtime (i.e., PTS_{prg}<spliceINtime)(for example access unit 810e, but not 810f, or access units 910e, f).

At stage 540, if the presentation time stamp, PTS_{prg}, of the access unit is not less than the spliceINtime (for example access unit 810f, 910g), then a splice-in procedure is performed to switch from transmitting access units of the program to the decoder to transmitting access units of the advertisement to the decoder. For example, a splicer (e.g., splicer 210 of FIG. 2) can perform a splice-in procedure to switch from transmitting access units of the program to the decoder to transmitting access units of the ad to the decoder to decode the coded frames of the ad for spliceOUTtime≦PTS_{ad}_{ᵢ}<spliceOUTtime. During this stage, the splicer can buffer the incoming program access units and in some implementations, the splicer buffers up to the two most recent group of pictures.

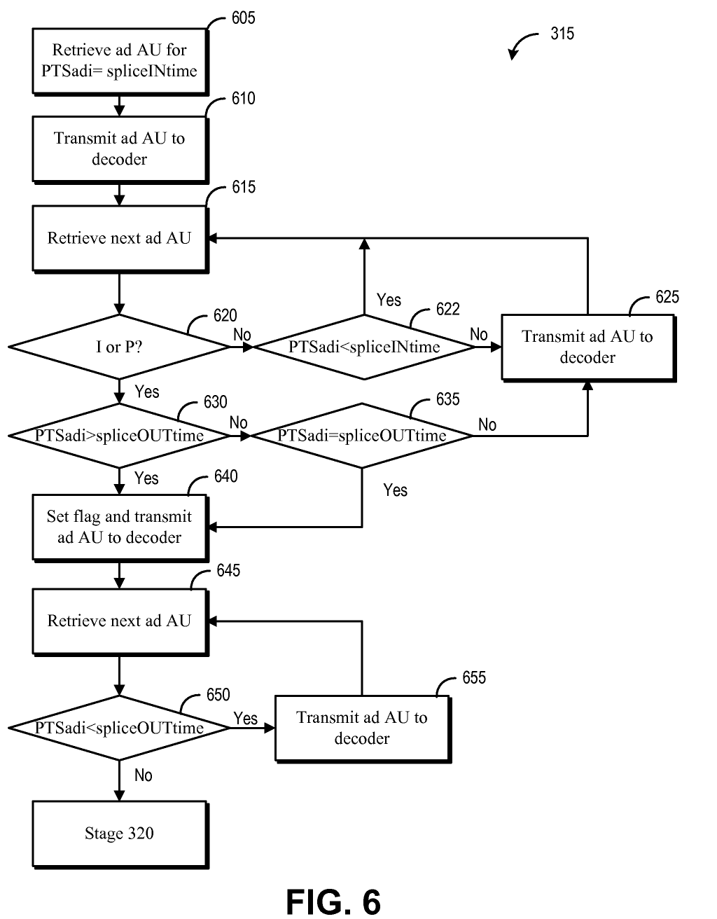

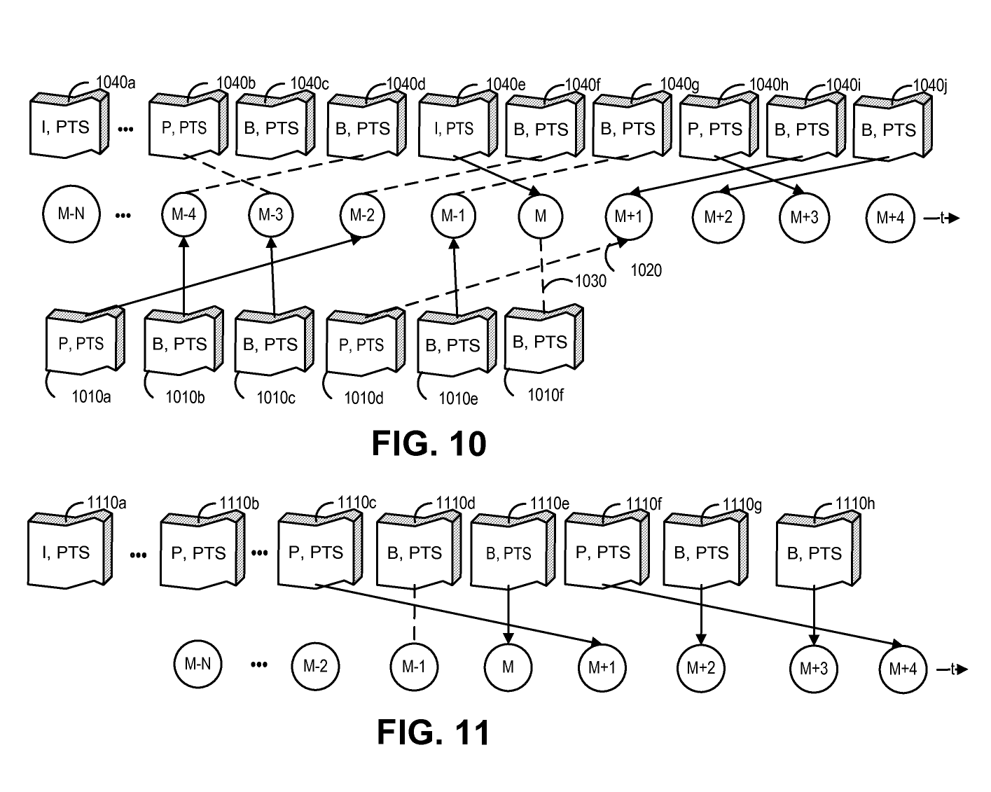

FIG. 6 illustrates an example process associated with stage 315 of the ad insertion process of FIG. 3 in more detail. The process of FIG. 6 will be described with reference to FIGS. 8 and 10. At stage 605, an advertisement access unit is retrieved. For example, a splicer (e.g., splicer 210 of FIG. 2) retrieves an ad access unit for PTS_{ad}_{_{i′}}=spliceINtime (for example access unit 860a). At stage 610, the advertisement access unit is transmitted to the decoder of transcoder. The advertisement access unit can be transmitted to the decoder of transcoder (e.g. transcoder 220 of FIG. 2) by a splicer (e.g., splicer 210 of FIG. 2).

At stage 615, the next advertisement access unit is retrieved. For example, a splicer (e.g., splicer 210 of FIG. 2) can retrieve the next ad access unit (for example, access unit 860b). At stage 620 a determination is made whether the coded frame of the access unit is a reference frame. For example, a splicer can determine whether the coded frame of the access unit is a reference frame (i.e., i-frame or p-frame).

If the coded frame of the access unit is not a reference frame (e.g., if the coded frame is a b-frame) the process can proceed to stage 622, where a determination is made whether the presentation time stamp of the access unit is less than the spliceINtime. For example, a splicer can determine whether the presentation time stamp, PTS_{ad}_{ᵢ}, of the access unit is less than the spliceINtime (i.e., whether PTS_{ad}_{_{i′}}<spliceINtime). If the presentation time stamp, PTS_{ad}_{ᵢ}, of the access unit is less than the spliceINtime (for example, the time stamp, PTS_{ad}_{ᵢ}, of the access unit 860b is less than the spliceINtime), the splicer does not transmit the access unit to the decoder (this is illustrated by the dotted line 870). The process then proceeds to stage 615 where the next ad access unit is retrieved. The next ad unit can be retrieved, for example, by a splicer. If the presentation time stamp, PTS_{ad}_{ᵢ}, of the access unit is not less than the spliceINtime, then at stage 625, the advertisement access unit can be transmitted to a decoder. For example, a splicer (e.g., splicer 210 of FIG. 2) can transmit the ad access unit to the decoder of transcoder (e.g., transcoder 220 of FIG. 2). The next ad access unit is retrieved at stage 615. For example, a splicer can continues to receive access units and transmit the access units to the decoder of transcoder or discard or otherwise ignore the access units until the splicer reaches the next reference frame (for example, the reference frame of access unit 860d) of the advertisement.

When the coded frame of the access unit is a reference frame (for example the coded frame of access unit 860d), the process proceeds to stage 630, where a determination is made whether the presentation time stamp, PTS_{ad}_{ᵢ}, of the access unit is greater than the spliceOUTtime. For example, a splicer can determine whether the presentation time stamp, PTS_{ad}_{ᵢ}, of the access unit is greater than the spliceOUTtime (i.e., whether PTS_{ad}_{ᵢ}>spliceOUTtime).

If PTS_{ad}_{ᵢ}, of the access unit is not greater than the spliceOUTtime (i.e., No at stage 630), then the process proceeds to stage 635, where a determination is made whether the presentation time stamp, PTS_{ad}_{ᵢ}, of the access unit is equal to the spliceOUTtime. For example, a splicer can determine whether the presentation time stamp, PTS_{ad}_{ᵢ}, of the access unit is equal to the spliceOUTtime (i.e., whether PTS_{ad}_{_{i′}}=spliceOUTtime).

If PTS_{ad}_{ᵢ}, of the access unit is not equal to the spliceOUTtime, then PTS_{ad}_{ᵢ}, of the access unit is less than the spliceOUTtime (for example, PTS_{ad}_{ᵢ}, of the access unit 860d is less than the spliceOUTtime) and, therefore, at stage 625 the advertisement access unit is transmitted to a decoder. For example, a splicer (e.g., splicer 210 of FIG. 2) transmits the ad access unit to the decoder of a transcoder (e.g., transcoder 220 of FIG. 2). At stage 615 the next ad access unit is retrieved. At this stage, for example, the splicer continues to transmit ad access units to the decoder of transcoder until it reaches the next reference frame of the ad.

When the coded frame of the access unit is a reference frame (i.e., YES at stage 620) and PTS_{ad}_{ᵢ}, of the access unit is greater than the spliceOUTtime (i.e., Yes at stage 630) (for example, PTS_{ad}_{ᵢ}, of the access unit 1010d is greater than the spliceOUTtime) or equal to the spliceOUTtime (i.e., Yes at stage 635), the process proceeds to stage 640 where a flag is set in the access unit to indicate the coded frame of the access unit is to be used to decode other coded frames of the advertisement. For example, a splicer can sets the flag (for example as represented by the dotted arrow 1020 for access unit 1010d) in the access unit to indicate that the coded frame of the access unit should be used to decode other coded frames of the ad having PTS_{ad}_{_{i′}}<spliceOUTtime (for example the coded frame for access unit 1010e) but should not be used as a decoder output and transmits the access unit to the decoder of transcoder.

Subsequent ad access units are retrieved at stage 645 (e.g., by splicer 210) and transmitted at stage 655 to a decoder so long as the presentation time stamp, PTS_{ad}_{ᵢ}, of the access unit is less than the spliceOUTtime (i.e., PTS_{ad}_{_{i′}}<spliceOUTtime) (Yes at stage 650)(for example access unit 1010e, but not 1010f.

At stage 650, if the presentation time stamp, PTS_{ad}_{ᵢ}, of the access unit is not less than the spliceOUTtime (if the presentation time stamp, PTS_{ad}_{ᵢ}, of the access unit is greater than or equal to the spliceOUTtime), then splicer 210 does not transmit the access unit to the decoder (for example as represented by dotted line 1030) and performs a splice-out procedure to switch back to transmitting certain access units of the program to the decoder of transcoder to decode the coded frames of the program for PTS_{prg}≧spliceOUTtime. These access units can include the access units for PTS_{prg}≧spliceOUTtime and, in some implementations, include other access units for PTS_{prg}<spliceOUTtime that can be used to decode the access units for PTS_{prg}≧spliceOUTtime.

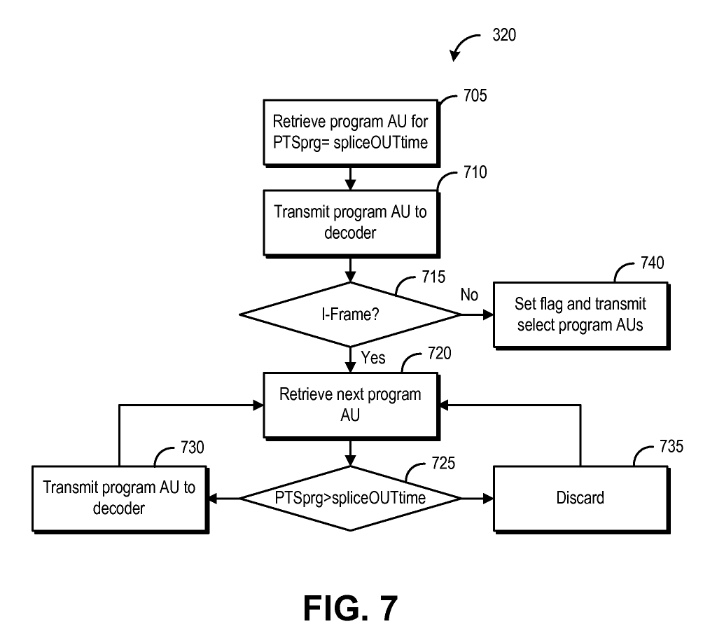

FIG. 7 illustrates an example process associated with stage 320 of the advertisement insertion process of FIG. 4 in more detail. The process of FIG. 7 will be described with reference to FIGS. 10 and 11. At stage 705, a program access unit for PTS_{prg}=spliceOUTtime is retrieved. For example, a splicer can retrieve a program access unit for PTS_{prg}=spliceOUTtime (for example access unit 1040e or access unit 1110e). At stage 710, the program access unit is transmitted to the decoder of a transcoder. At stage 715, a determination of whether the coded frame of the access unit is an anchor frame is made. For example, the splicer can determine whether the coded frame of the access unit is an anchor frame (e.g., i-frame). If the coded frame is an anchor frame (for example coded frame of access unit 1040e is an i-frame), the next program access unit is retrieved at stage 720. For example, a splicer can retrieve the next program access unit (for example access unit 1040f). At stage 725 a determination is made whether the presentation time stamp, PTS_{prg}, of the access unit is greater than the spliceOUTtime (i.e., whether PTS_{prg}>spliceOUTtime). If PTS_{prg}>spliceOUTtime, the process proceeds to stage 730, where the program access unit is transmitted to a decoder. For example, a splicer can transmit the program access unit to the decoder of a transcoder. If the presentation time stamp, PTS_{prg}, of the access unit is not greater than the spliceOUTtime (for example PTS_{prg} of access unit 1040f is not greater than the spliceOUTtime), then in some implementations, the access unit can be discarded or otherwise ignored at stage 735. The splicer can continue to receive access units and transmit the access units to the decoder of the transcoder (represented by solid arrows in FIGS. 10 and 11) or discard or otherwise ignore the access units and not transmit the access units to the decoder (represented by dotted lines in FIGS. 10 and 11) until the splicer reaches the last access unit for the program or until the next splice-in opportunity.

Returning to stage 715, if the coded frame is not an anchor frame (e.g., if the coded frame is a p-frame or b-frame), for example the coded frame of access unit 1110e, the most recently coded i-frame (for example the coded frame for access unit 1110a) and all subsequently coded p-frames (for example the coded frame for access unit 1110b) of the program up to (but not including) the coded frame for PTS_{prg}=spliceOUTtime (although they may not be displayed) may be used to decode other coded frames of the program in which PTS_{prg}≧spliceOUTtime (for example the coded frame for access unit 1110e) that will be displayed. Thus, at stage 740, for each of the most recently coded i-frames and all subsequently coded p-frames of the program up to (but not including) the coded frame for PTS_{prg}=spliceOUTtime, a flag is set in the access unit if PTS_{prg}<spliceOUTtime, and the access unit can be transmitted to a decoder. For example, a splicer can set a flag in the access unit if PTS_{prg}<spliceOUTtime and can transmit the access unit to the decoder of transcoder. The flag can be used to indicate that the corresponding coded frame of the access unit should be used to decode other coded frames of the video sequence having PTS_{prg}≧spliceOUTtime (for example the coded frame for access unit 1110e) but should not be used as a decoder output. At stage 720, access units can be continued to be retrieved. For example, splicer 210 can continue to retrieve access units and transmit the access units to the decoder of transcoder (represented by solid arrows) or discard or otherwise ignore the access units and not transmit to the access units to the decoder (represented by dotted lines) until it reaches the last access unit for the program or until the next splice-in opportunity.

The video elementary stream received by the decoder of transcoder representing the original digital video streams with ad insertion includes each access unit of the program for PTS_{prg}<spliceINtime followed by each access unit of the advertisement for spliceINtime≦PTS_{ad}_{_{i′}}<spliceOUTtime followed by each access unit of the program for PTS_{prg}≧spliceOUTtime. As discussed above, the video elementary stream 240 can also include additional access units of the video sequence and advertisement containing coded frames that will not be displayed but are needed to decode other coded frames of the video sequence and/or advertisement that will be displayed.

Until now, it has been assumed that the spliceINtime and spliceOUTtime corresponds to a PTS of a coded frame. However, in some examples, this might not be the case. If the spliceINtime does not correspond to a PTS of a coded frame of the program, then the spliceINtime can be adjusted to correspond to a PTS of a coded frame of the program. In some implementations, the spliceINtime can be adjusted to equal the smallest PTS of the coded frames of the program that is greater than spliceINtime. Thus, in such implementations, spliceINtime′=min(PTS_{prg}_{ᵢ}>spliceINtime. Accordingly, spliceINtime′ is used in place of spliceINtime for the processes described above. For example, at stage 425 of FIG. 4, the splicer re-computes the presentation time stamp for the coded frames of the advertisement, PTS_{ad}, based on the spliceINtime′. In some implementations, the splicer can re-computes the presentation time for the i-th coded frame of the advertisement, PTS_{ad}_{ᵢ}, based on the following equation:

PTS_{ad}_{_{i′}}=PTS_{ad}_{ᵢ}+offset

where offset=spliceINtime′−PTS_{ad}_{₁} and

PTS_{ad}_{₁} is the presentation time for the first coded frame of the advertisement.

If the spliceOUTtime does not correspond to a PTS of a coded frame of the program, then the spliceOUTtime can be adjusted to correspond to a PTS of a coded frame of the program. In some implementations, the spliceOUTtime is adjusted to equal the largest PTS of the coded frames of the program that is less than spliceOUTtime. That is spliceOUTtime′=max(PTS_{prg}_{ᵢ}<spliceOUTtime). Accordingly, spliceOUTtime′ is used in place of spliceINtime for the processes describe above.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. A method comprising:
receiving a first video stream including coded frames of a first program;
receiving a second video stream including coded frames of a second program;
decoding select coded frames of the first program to obtain a first set of pixel level pictures;
decoding select coded frames of the second program to obtain a second set of pixel level pictures;
combining the first set of pixel level pictures and the second set of pixel level pictures to obtain a third set of pixel level pictures; and
encoding at a predetermined bit rate the third set of pixel level pictures to obtain a third program.

2. The method of claim 1 wherein decoding select coded frames of the first program to obtain a first set of pixel level pictures comprises decoding each coded frame of the first program where the presentation time stamp of the coded frame is less than a first time and greater than or equal to a second time.

3. The method of claim 2 wherein decoding select coded frames of the second program to obtain a second set of pixel level pictures comprises decoding each coded frame of the second program where the presentation time stamp of the coded frame is greater than or equal to the first time and less than the second time.

4. The method of claim 3 wherein the third set of pixel level pictures comprises the first set of pixel level pictures corresponding to the coded frames of the first program where the presentation time stamp of the coded frames are less than the first time followed by the second set of pixel level pictures corresponding to the coded frames of the second program where the presentation time stamp of the coded frames are greater than or equal to the first time and less than the second time followed by the first set of pixel level pictures corresponding to the coded frames of the first program where the presentation time stamp of the coded frames are greater than or equal to the second time.

5. The method of claim 1 wherein the second program is an advertisement.

6. The method of claim 1 wherein the first video stream is either a single program transport stream or a multiple program transport stream as defined in the MPEG-2 standard.

7. The method of claim 1 wherein the predetermined bit rate is determined based on statistical multiplexing.

8. A computer-readable medium having embodied thereon a computer program, the computer program comprising:
one or more first code segments operable to receive a first video stream including coded frames of a first program and decode select coded frames of the first program to obtain a first set of pixel level pictures;
one or more second code segments operable to receive a second video stream including coded frames of a second program and decode select coded frames of the second program to obtain a second set of pixel level pictures;
one or more third code segments operable to combine the first set of pixel level pictures and the second set of pixel level pictures to obtain a third set of pixel level pictures; and
one or more fourth code segments operable to encode at a predetermined bit rate the third set of pixel level pictures to obtain a third program

9. The computer-readable medium of claim 8 wherein the one or more first code segments are operable to decode each coded frame of the first program where the presentation time stamp of the coded frame is less than a first time and greater than or equal to a second time.

10. The computer-readable medium of claim 8 wherein the one or more second code segments are operable to decode each coded frame of the second program where the presentation time stamp of the coded frame is greater than or equal to the first time and less than the second time.

11. A system comprising:
a splicer operable to receive a first program and a second program and select a first set of coded frames of the first program and a second set of coded frames of the second program and transmit to the transcoder; and
a transcoder operable to decode the first set of coded frames to obtain a first set of pixel level pictures and the second set of coded frames to obtain a second set of pixel level pictures and operable to combine the first set of pixel level pictures and the second set of pixel level pictures to obtain a third set of pixel level pictures and operable to encode at a predetermined bit rate the first set of pixel level pictures and the second set of pixel level pictures to obtain a third program.

12. A system comprising:
means for receiving a first video stream including coded frames of a first program;
means for receiving a second video stream including coded frames of a second program;
means for decoding select coded frames of the first program to obtain a first set of pixel level pictures;
means for decoding select coded frames of the second program to obtain a second set of pixel level pictures; and
means for combining the first set of pixel level pictures and the second set of pixel level pictures to obtain a third set of pixel level pictures; and
means for encoding at a predetermined bit rate the third set of pixel level pictures to obtain a third program.

13. The system of claim 12 wherein means for decoding select coded frames of the first program to obtain a first set of pixel level pictures comprises means for decoding each coded frame of the first program where the presentation time stamp of the coded frame is less than a first time and greater than or equal to a second time.

14. The method of claim 12 wherein means for decoding select coded frames of the second program to obtain a second set of pixel level pictures comprises means for decoding each coded frame of the second program where the presentation time stamp of the coded frame is greater than or equal to the first time and less than the second time.
